(19) United States
(12) Patent Application Publication
(10) Pub. No.: US 2026/0298261 A1
(43) Pub. Date: Oct. 1, 2026

(54) TWO-STAGE RADIAL COMPRESSOR WITH COMPENSATING BODIES FOR COMPENSATING A CHANGE IN LENGTH OCCURRING UPON A CHANGE IN TEMPERATURE

(71) Applicant: ebm-papst Mulfingen GmbH & Co. KGaA & Co. KG, Mulfingen (DE)

(72) Inventors: Mihai B. Dobrica, Heidelberg (DE); David Klupfel, Kleinrinderfeld (DE)

(21) Appl. No.: 19/635,957

(22) Filed: Apr. 1, 2026

(30) Foreign Application Priority Data
Apr. 1, 2025 (DE) 10 2025 112 725.5

(51) Int. Cl. F04D 29/42; F03G 7/06; F04D 17/12; F04D 29/28

(52) U.S. Cl. CPC F04D 29/4206; F03G 7/06114; F04D 17/12; F04D 29/286

(57) ABSTRACT

A two-stage radial compressor with a housing and a rotor, the two impellers of which are arranged on opposing end portions of a shaft, wherein the radial compressor has compensating bodies arranged in or on the housing for compensating a difference between the changes in length of the rotor and the housing occurring upon a change in temperature.

### RELATED APPLICATIONS

The present disclosure claims priority to and the benefit of German Application No. 10 2025 112 725.5, filed on Apr. 1, 2025, the entire contents of which is incorporated herein by reference.

### FIELD

The present disclosure relates to a two-stage radial compressor, the two impellers of which are arranged on opposing end portions of a shaft, wherein the radial compressor has compensating bodies for compensating a change in length occurring upon a change in temperature.

### BACKGROUND

Two-stage radial compressors in a so-called “end-to-end” configuration are known in the art. With these, an impeller is provided on each of the opposing ends of a shaft such that the inlet sides of the compressor stages each defined by an impeller are facing away from one another and the end portions of the compressor stages are facing one another.

With compressors in general and with radial compressors specifically, the axial orientation is particularly important, since a predetermined distance preferably as small as possible between the respective impeller and the bordering housing portion, which, with radial compressors, is referred to as a volute housing or volute housing portion, needs to be set to allow for the intended compression.

Accordingly, the shaft of radial compressors is supported axially, wherein the axial support of the shaft is often implemented bordering one of the impellers, such that a first impeller of the radial compressor is substantially immediately adjacent to the axial support and a second impeller of the radial compressor is spaced apart from the axial support in the longitudinal direction of the shaft.

As for almost all materials, the materials, which such radial compressors are made of, expand according to a material-specific thermal expansion coefficient upon an increase in temperature or shrink according to the thermal expansion coefficient upon a decrease in temperature.

Although there is also a change in dimensions in the radial direction, with the radial compressors described, a change in dimensions along the shaft, i.e., in the longitudinal direction, is particularly important, since it strongly affects the distance between the impellers and the respective bordering housing or volute housing portions.

This results from the tolerance chain being small at the first impeller and the housing portion bordering thereto close to the axial support, a change in length thus has only a small effect, but being large at the second impeller and the housing portion bordering thereto, since these are spaced apart from the axial support, such that a change in length resulting from a change in temperature has a strong effect and may result in a reduced efficiency of the compressor or even a physical damage.

This issue is known, such that the basic technical object is to ensure that the relative thermal deformation of the shaft and the housing is as similar as possible, independently from the variations in temperature of the compressor in order for the relative positioning of the impellers and the respective volute housing or volute housing portion is maintained, independently from the thermal surrounding and operational conditions.

A trivial solution would be making the housing from the same material as the shaft to obtain the same thermal expansion behavior. In practice, however, we have found this is disadvantageous and undesirable, since the material of the shaft often is expensive or fragile material such as high precision ceramic, for example. Therefore, such materials are not suitable for a massive and optionally shock-loaded housing.

### BRIEF SUMMARY

Therefore, the present disclosure overcomes the aforementioned disadvantages and provides a two-staged compressor which, when being operated, will not be damaged upon or following changes in temperature and will continue to be operable with high efficiency or without any efficiency losses.

According to the present disclosure, a two-stage radial compressor with a housing and a rotor supported in the housing is proposed. The rotor has a first impeller, a second impeller, and a shaft having a respective one of the two impellers fixed to the opposing end portions or opposing front ends, which corresponds to an “end-to-end” configuration. The rotor has a specifically predetermined or known first thermal expansion coefficient which may also result from multiple and optionally also different thermal expansion coefficients of the several components of the rotor, such as the shaft and the two impellers. Accordingly, the first thermal expansion coefficient causes a change in length of the rotor upon a change in temperature.

In a simplified manner, it is assumed that the change in temperature is substantially identical for the rotor and the housing. Furthermore, it should be clarified that the length is understood as the extension of the respective component along a rotational axis coaxial to the shaft, around which the shaft or the rotor is rotatably arranged, such that the change in length of the rotor corresponds to the change in dimensions of the rotor along the rotational axis. Similarly, the housing has a specifically predetermined or known second thermal expansion coefficient which, in turn, may also result from multiple and optionally also different thermal expansion coefficients of the several components of the rotor, such as the housing portions mentioned below. The second thermal expansion coefficient is different from the first thermal expansion coefficient, causing a change in length of the housing different from the change in length of the rotor upon the change in temperature, such that different and consequently disadvantageous changes in lengths would result.

According to the present disclosure, it is therefore provided that at least two compensating bodies extending parallel to the shaft or also parallel to the rotational axis are arranged in or on the housing, which have a third thermal expansion coefficient and are configured to cause, upon the or a change in temperature and/or predetermined differing temperatures of the rotor and housing, a predetermined change in length of the housing and adjust the change in length of the housing to the change in length of the rotor, such that the change in length of the housing substantially corresponds to the change in length of the rotor upon the change in temperature. Consequently, the features according to the present disclosure result in highly similar or almost identical changes in length in the rotor and the housing, and the respective relative positioning of the impellers relative to a respective bordering housing portion or a respective associated volute housing portion substantially remains the same or changes only slightly despite the change in temperature.

In summary, the present disclosure relates to a two-stage radial compressor with a housing and a rotor, the two impellers of which are arranged on opposing end portions of a shaft, wherein the radial compressor has compensating bodies arranged in or on the housing for compensating a difference be-tween the changes in length of the rotor and the housing occurring upon a change in temperature.

The compensating bodies may also be referred to as compensating elements or compensating rods.

Regarding the thermal expansion coefficients, it should be noted that the first thermal expansion coefficient of the rotor may be greater than the second thermal expansion coefficient of the housing. However, essentially, the contrary may also be possible.

By correspondingly choosing the thermal expansion characteristics or the thermal expansion coefficients of the compensating bodies with respect to the thermal expansion characteristics or the thermal expansion coefficients of the rotor and the housing, the thermal expansion characteristics of the housing of the radial compressor may be controlled such that a same thermal behavior occurs with respect to the axial extension or the change in length of the rotor and the housing. This ensures that the housing and the rotor or particularly the shaft deform by the same amount if the radial compressor is subjected to variations in temperature while being idle, e.g., during storage, transport or not being in use, or being operated.

In addition, in operation and particularly under extreme operating conditions, different changes in temperature may occur at the rotor and the housing, thereby resulting in different temperatures or different temperatures levels for the rotor and the housing. Therefore, according to an advantageous development, it may be provided that the first thermal expansion coefficient and/or the second thermal expansion coefficient and/or the third thermal expansion coefficient with respect to these different temperature levels are chosen such that, with predetermined occurring temperature levels, the changes in length at the housing and the rotor resulting from the different thermal expansion coefficients substantially are the same.

Consequently, the first thermal expansion coefficient of the rotor and an equivalent thermal expansion coefficient from the first thermal expansion coefficient and the second thermal expansion coefficient may be different from one another, causing in turn, with predetermined different temperatures at the rotor and the housing, a substantially identical change in length of the rotor and the housing.

Apart from the already outlined advantages and the cost savings with respect to the otherwise known variations, the distances and tolerances of the compressors may additionally be smaller, since the different extensions in length do not need to be considered in the design any longer. This may further increase the efficiency of the compressor.

According to the present disclosure, the compensating bodies may be made of the same material the shaft is made of. Alternatively, however, the compensating bodies may also be made of a material different therefrom configured by a corresponding thermal expansion coefficient to cause the desired change in length at the housing.

Preferably, it is provided that the compensating bodies are evenly distributed around the shaft in the circumferential direction. Basically, however, a varying distribution may also be provided, causing an even change in length at the housing.

Furthermore, the compensating bodies may each have a circular, rectangular or polygonal, particularly hexagonal, cross-section.

Additionally or alternatively, a respective longitudinal axis of the compensating bodies may run parallel and eccentrically, i.e., non-coaxially, to the shaft or the rotational axis.

In order to arrange the compensating bodies on the housing, receptacles may be provided in or on the housing, each corresponding to one of the compensating bodies. A respective compensating body is inserted in a respective one of the receptacles.

Preferably, the housing of the radial compressor has a first volute housing portion corresponding to the first impeller, a second volute housing portion corresponding to the second impeller, and a stator housing portion arranged between the two volute housing portions, which preferably fully receives a stator of a motor driving the rotor around the rotational axis.

On this basis, an advantageous development provides that the receptacles are formed at least partially by the housing and particularly by the first volute housing portion and/or the second volute housing portion and/or the stator housing portion.

Independently therefrom or also additionally, it may also be provided that the receptacles are formed at least partially by a particularly cylindrical compensating portion of the housing, which extends coaxially to the shaft inside or outside the stator housing portion.

If a compensating portion is provided, a sealing plane may be formed between the same and the portion, for example the stator housing portion, bordering in the radial direction.

Furthermore, the compensating portion may be fixed towards a front end to one of the volute housing portions and may be configured towards the opposing side to abut to the other volute housing portion or the stator housing portion.

The compensating bodies may be arranged in or on the stator housing portion and particularly abut the stator housing portion with at least a front end.

Furthermore, the compensating bodies may be arranged between the first volute housing portion and the second volute housing portion, such that a change in length of the compensating bodies along the rotational axis causes a change of the distance of the two volute housing portions to one another.

Furthermore, the compensating bodies may each abut the first volute housing portion and/or the second volute housing portion.

The compensating bodies, regarding their length along the rotational axis, may have a length smaller or greater than the length of the housing or the stator housing portion. Furthermore, it is also possible that the compensating bodies have a length equal to the length of the volute housing portion, such that the compensating bodies abut the volute housing portions on both sides.

Based on a division of the housing into the mentioned portions, the stator housing portion may be integrally formed with the first volute housing portion or the second volute housing portion as one body.

Alternatively, the stator housing portion, the first volute housing portion, and the second volute housing portion may each be formed as a separate body.

In both variations, it is preferably provided that a connection and/or seal between the stator housing portion, the first volute housing portion, and the second volute housing portion is configured to resist the change in length and particularly the change in length caused by the compensating bodies on the housing, i.e., to maintain the intended function.

The compensating bodies may each be integrally formed or divided into multiple subbodies in the longitudinal direction. If multiple subbodies per compensating body are provided, these may each have an own portion in an associated receptacle, which allows for the individual changes in length of the subbodies to be transferred more easily and evenly to the housing and particularly the stator housing portion thereof.

Furthermore, the compensating bodies may each be connected to the housing, transferring a change in length to the housing at multiple locations in the longitudinal direction, which may be implemented, for example, by projections or springs engaging with grooves like a groove/spring connection.

The features disclosed above are combinable as required, provided this is technically possible and they do not contradict one another.

### BRIEF DESCRIPTION OF THE DRAWINGS

Other advantageous developments of the present disclosure are characterized in the dependent claims or illustrated in greater detail below together with the description of the preferred embodiment of the present disclosure with reference to the figures. In the drawings:

FIG. 1 shows a longitudinal section along the rotational axis through a two-stage compressor;

FIG. 2a-c show several configurations of a compensating portion with compensating bodies arranged therein.

The figures are schematic examples. Same reference numerals in the figures indicate same functional and/or structural features.

### DETAILED DESCRIPTION

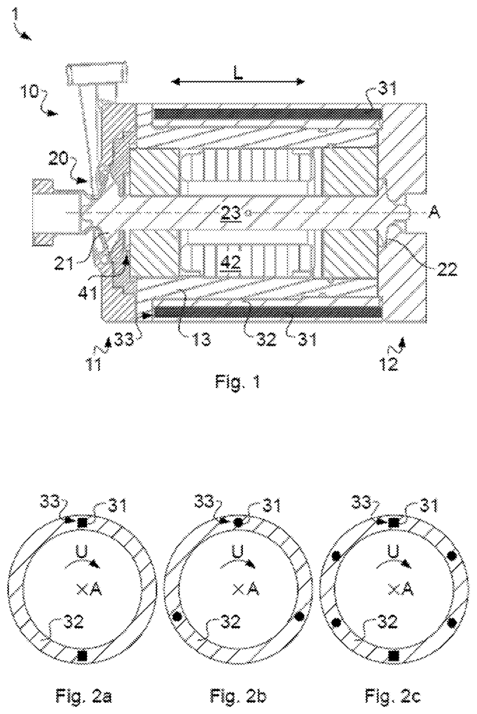

FIG. 1 illustrates a two-stage radial compressor 1 configured according to the present disclosure. It has a housing 10 and a rotor 20 supported therein and rotatable around a rotational axis A, wherein the rotor 20 substantially has a shaft 23 with two impellers 21 arranged on the terminal and front end thereof, respectively.

Regarding its axial position, the rotor 20 is supported and fixed in the housing 10 by an axial bearing 41, wherein the first impeller 21 borders the axial bearing 41 or the distance of the first impeller 21 to the axial bearing 41 is significantly smaller than the distance of the second impeller 22 to the axial bearing 41, which is spaced apart from the axial bearing 41 by substantially the longitudinal extension of the shaft 23.

Since the components of the rotor 20 and the components of the housing 10 have different thermal expansion characteristics and specifically different thermal expansion coefficients, the rotor 20 and the housing 10 behave differently regarding a respective change in length in the longitudinal direction L, i.e., along the rotational axis A upon changes in temperature. Consequently, the efficiency of the radial compressor 1 may be reduced or it may even be damaged, since the axial position of the second impeller 22 particularly changes with respect to the housing 10.

In order to ensure a continuously high efficiency and prevent damage, it is provided that the radial compressor has at least two compensating bodies 31 extending parallel to the shaft 23. These have a third thermal expansion coefficient and are configured to adjust the change in length of the housing 10 to the change in length of the rotor 20, such that the change in length of the housing 10 along the longitudinal axis L corresponds to the change in length of the rotor 20 upon the change in temperature.

To this end, apart from a first volute housing portion 11 corresponding to the first impeller 21, a second volute housing portion 12 corresponding to the second impeller 22, and a stator housing portion 13 of the housing 10 arranged therebetween and fully receiving a stator 42 of a motor for rotatably driving the rotor 20 around the rotational axis A, it has a compensating portion 32 annularly or cylindrically surrounding the rotational axis A and radially outward bordering the stator housing portion 13 according to the depicted variation.

Receptacles 33 for receiving the compensating bodies 31 are provided in the compensating portion 32, wherein the receptacles 33 herein completely pass through the compensating portion 32 in the longitudinal direction L.

The compensating portion 32 is fixed to the second volute housing portion 12 on the side of the second impeller 22 and borders a flange formed by the stator housing portion 13 on the side of the first impeller 21.

If there is a change in length by the compensating bodies 31 arranged in the receptacles 33, these push in the longitudinal direction L with their front ends against the second volute housing portion 12 and on the first volute housing portion 11 via the flange of the stator housing portion 13, such that the volute housing portions 11, 12 are pushed apart in the longitudinal direction.

The configuration illustrated compensates the change in length in the region of the stator housing portion 13 by a relative displacement of the stator housing portion 13 and the compensating portion 32, wherein a cylindrical sealing plane is formed therebetween in the radial direction.

FIGS. 2a to 2c illustrate the cross-sections of compensating portions 32 having receptacles 33 with compensating bodies 31 provided in several configurations.

Basically, it should be noted that at least two compensating bodies 31 are provided according to the present disclosure, wherein the compensating bodies 31 may each have several cross-sections and may be arranged in several orientations around the rotational axis A.

FIG. 2a illustrates a simple first variation, in which exactly two compensating bodies 31 are provided, having an exemplary square cross-section and being arranged opposite one another in the compensating portion 32 of the housing 10.

Deviating from this, FIG. 2b shows three compensating bodies 31 which are evenly distributed around the rotational axis A in the circumferential direction U and have a round cross-section.

According to the variation, as shown in FIG. 2c, six compensating bodies 31 are provided, wherein respective two opposing compensating bodies 31 have identical cross-sections and compensating bodies 31 are provided with round, rectangular and hexagonal cross-sections. In particular, this may also be used for encoding, since then only the predetermined compensating bodies 31 are insertable into the respective corresponding receptacles 33 with respect to their shape.

Practice of the present disclosure is not limited to the preferred exemplary embodiments set forth above. Instead, a number of variations may be contemplated which make use of the solution illustrated even in fundamentally different embodiments.

1. A two-stage radial compressor with a housing and a rotor supported within the housing that has a first impeller, a second impeller and a shaft having a respective one of the two impellers fixed to the opposing end portions thereof,
wherein the rotor has a first thermal expansion coefficient causing a change in length of the rotor upon a change in temperature,
wherein the housing has a second thermal expansion coefficient different from the first thermal expansion coefficient and causing a change in length of the housing different from the change in length of the rotor upon the change in temperature, and
wherein at least two compensating bodies extending parallel to the shaft are arranged in or on the housing, the at least two compensating bodies having a third thermal expansion coefficient and are configured to cause, upon the change in temperature and/or predetermined differing temperatures of the rotor and housing, a predetermined change in length of the housing and adjust the change in length of the housing to the change in length of the rotor, such that the change in length of the housing corresponds to the change in length of the rotor upon the change in temperature.

2. The radial compressor according to claim 1,
wherein the compensating bodies are evenly distributed around the shaft in the circumferential direction.

3. The radial compressor according to claim 1,
wherein the compensating bodies each have a circular, rectangular or polygonal, particularly hexagonal, cross-section,
and/or a respective longitudinal axis of the compensating bodies runs parallel and eccentrically to the shaft.

4. The radial compressor according to claim 1,
wherein receptacles are provided in or on the housing, each corresponding to one of the compensating bodies, and
wherein a respective compensating body is inserted in a respective one of the receptacles.

5. The radial compressor according to claim 1,
wherein the housing has a first volute housing portion corresponding to the first impeller, a second volute housing portion corresponding to the second impeller, and a stator housing portion arranged between the two volute housing portions, which fully receives a stator of a motor driving the rotor.

6. The radial compressor according to claim 5,
wherein receptacles are provided in or on the housing, each corresponding to one of the compensating bodies, the receptacles being formed at least partially by the first volute housing portion and/or the second volute housing portion and/or the stator housing portion,
and/or wherein a respective compensating body is inserted in a respective one of the receptacles, the receptacles being formed at least partially by a compensating portion of the housing which extends coaxially to the shaft inside or outside the stator housing portion.

7. The radial compressor according to claim 6,
wherein the compensating bodies are arranged in or on the stator housing portion and particularly abut the stator housing portion with at least a front end,
and/or wherein the compensating bodies are arranged between the first volute housing portion and the second volute housing portion, such that a change in length of the compensating bodies causes a change of the distance of the two volute housing portions to one another,
and/or wherein the compensating bodies each abut the first volute housing portion and/or the second volute housing portion.

8. The radial compressor according to claims 5,
wherein the compensating bodies have a length smaller or greater than the length of the housing or the stator housing portion.

9. The radial compressor according to claim 5,
wherein the stator housing portion is integrally formed with the first volute housing portion or the second volute housing portion as one body.
or wherein the stator housing portion, the first volute housing portion, and the second volute housing portion are each formed as one body,
and wherein a connection and/or seal between the stator housing portion, the first volute housing portion, and the second volute housing portion is configured to resist the change in length.

10. The radial compressor according to claim 1,
wherein the compensating bodies are each integrally formed or divided into multiple subbodies in the longitudinal direction (L),
and/or wherein the compensating bodies are each connected to the housing, transferring a change in length to the housing at multiple locations in the longitudinal direction.
